(19) United States
(12) Patent Application Publication
(10) Pub. No.: US 2008/0228672 A1
(43) Pub. Date: Sep. 18, 2008

(54) Sales process and form

(76) Inventor: Michael Kearns, Franklin, VA (US)

Correspondence Address: Bradley D. Goldizen, One Columbus Center, Ste. 665, Virginia Beach, VA, 23462, US

(21) Appl. No.: 12/074,324

(22) Filed: Mar. 3, 2008

Related U.S. Application Data
(60) Provisional application No. 60/904,720, filed on Mar. 3, 2007.

(51) Int. Cl. G06Q 90/00

(52) U.S. Cl. 705/500

(57) ABSTRACT

A novel business method for selling automobiles includes a unique multiply form that includes three different data fields. The form is used in a paperwork tracking technique that comprises multiple sheets having a common data field in a pre-selected area. Each sheet includes other data fields that are unique to that particular form. Each sheet is stripped from the multi-ply form and forwarded to an appropriate department in an automobile dealership.

The present application relates to U.S. Provisional Patent Application Ser. No. 60/904,720 filed on Mar. 3, 2007 and claims priority therefrom.

The instant application did not receive any federal research and development funding.

### TECHNICAL FIELD

Generally the invention relates to a novel sales process that is preferably used in selling items that have unique identifiers such as serial numbers or street addresses. More particularly, the unique sales process includes a form that comprises several sheets or plies of paper, each sheet having common identifier information displayed thereon in a common region such that common information relating to the item that is being sold and the customer are reproduced in the same area of each sheet. The process is particularly useful for use in automobile sales, house or real estate sales and boat sales. It should be noted that the process may be used for any sales process requiring multiple forms with each have common information displayed thereon. The form may include a strip of carbon paper arranged between respective plies of the form in the region that includes the common information. Otherwise, the form may be carbonless and having known treatments applied to the back of each ply or front of each ply in the area where the common information is reproduced, in the first data region. In this manner, one may write on the top copy of the form and only transfer common information onto the succeeding plies of paper without transferring other information specific to a particular agency or department. For example, common information is written onto the top ply and is transferred to all plies or sheets. Specific information that is only used by a particular department or agency may be also written into the second data region. In a third data region, common information, such as a trademark, service mark, logo, dealership name, broker or real estate sales name is reproduced when the form is initially created. Thus, information in the first region written onto the top copy is reproduced onto each succeeding sheet. Information written in the second data region is not transferred from the top ply that is written upon to any succeeding sheets of the form. Thus, the form is presented to a sales person who verifies and enters information into selected blanks in each data region. The sales person then removes the top copy and passes the remaining sheets of the form onto a second department whose employees enter addition information onto the second ply of the form. The information entered by the employees of the second department may include only information specific to the second department, or alternatively information that may be reproduced on one or more of the succeeding plies in a common area. This entry of information can continue until the last sheet is passed to the last department. Otherwise, the sales person may enter common information thereafter disassemble the sheets of the form and pass a respective sheet to an appropriate department.

### BACKGROUND OF THE INVENTION

Automobile dealerships have existed from the early part of the twentieth century. Many dealerships include finance departments and maintenance departments. Both the finance and maintenance departments may become involved in the sales process for selling vehicles. Typically, each department has its own forms that include blank areas or lines that are filled in, by the salesman, with specific information relating to the customer or automobile, in order to process the sales of an automobile. The sales and transfer of ownership of both boats and houses may also include several forms that are necessary for legally transferring title from one to another.

Selling an automobile is a somewhat stressful process for both the salesperson and the consumer. The stress tends to lead to mistakes being made on the forms that are used internally within the dealership or other such business. Moreover, many salespersons have handwriting that is difficult for others to read. The mistakes and sloppy handwriting may complicate the sales process. For example, there are several different forms that are involved in selling an automobile. Some of these forms may include sales worksheets, finance documents and maintenance checklists. Much of the information displayed on these forms is common to all of the forms. If several different agents of the dealership fill out the various forms, or alternatively when a single person fills out the forms, mistakes are typically made. These mistakes delay the transferring of the ownership rights and title from one to another. Likewise, real estate and boat sales are also other types of sales that require various forms that may include sales worksheets having financial documents and checklists that may be provided to a plurality of users. During the sales process of any of these “big ticket items”, certain information must be reproduced for each department of the automobile dealership or business. The term “big ticket items” refers to expensive items that are typically sold for thousands of Dollars or Euros.

### SUMMARY OF THE INVENTION

A sales process includes a unique form that comprises at least two data fields and preferably three. In an embodiment, the first data field is data relating to a particular automobile and which is used by all departments of the automobile dealership to facilitate its sale. The first data also preferably includes customer specific information such as name and contact information. The second data field includes information which is for use by a particular department of the dealership. In an additional embodiment, a company logo or trademark is reproduced in a third data field that is common to each sheet of the form. Thus, the instant invention is preferably used in an automobile dealership to optimize the automobile sales process.

A first data field is provided on all of the sheets of the form and includes information that may be filled in by hand, typewriter or electronic printer. The first data region includes blank areas for data entry that includes information that is common to a particular automobile and which is reproduced on all of the sheets. That is, the first data region includes data used by all departments of the automobile dealership. Data entered into the first data region is data specific to a particular automobile that the customer is interested in purchasing, as well as information that is unique to the customer. By filling out these types of data only once, the likelihood of having a mistake is minimized. Moreover, filling the information out only once, creates a process that is optimized by reducing the amount of time for filling out the various forms necessary for selling the automobile. Thus, the overall stress associated with purchasing an automobile may be alleviated.

A second data region is provided on each sheet of paper and includes data or information that is unique to only that particular sheet of paper or one or more of the succeeding sheets of paper. The data entered in the second data field is important to various divisions of an automobile dealership, such as the sales department, finance department and maintenance department. The data may be considered important by multiple departments.

A third data field is reproduced on all of the forms and typically comprises a company logo or trademark. This third data field is printed when the data entry fields of the first and second data regions are printed or generated on an electronic data entry device. In this manner, a sales or intake person may fill out the first data field for a particular automobile. Thereafter, the paperwork form may be disassembled and a particular copy forwarded to the appropriate department of the automobile dealership for further processing.

It is an object of the invention provide a form that reduces mistakes made by representatives of an automobile dealership by automatically reproducing information relating to the automobile to be sold and the customer's information on multiple forms. Each form is necessary for transferring ownership of the automobile from the dealership to the customer.

It is a further object of the invention to teach a process of selling an item such as an automobile, boat or real estate through the use of a single form that automatically reproduces information written on a first sheet of paper onto a plurality of succeeding sheets arranged behind the first sheet. Only a first region that comprises the first data reproduces information on succeeding sheets of paper. In this manner, the information that is not common to all of the sheets of paper is not transferred onto the succeeding sheets of paper.

It is another object of the invention to teach a single form that includes a plurality of sheets of paper. Each sheet of paper is for use by a department in an automobile dealership, real estate sales or other such retail or wholesale sales organizations. In a preferred embodiment, the form includes a financial worksheet, a used automobile appraisal form, a payoff and title guarantee sheet, a service or maintenance department sheet, a customer incentive sheet, a privacy notice, and a sales and financing department checklist. It should be recognized that the form may be modified to accommodate various other types of sales organizations and departments as referenced herein or may be recognized by the skilled artisan.

Additional objects and advantages of the invention will be set forth in part in the description that follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE VIEWS

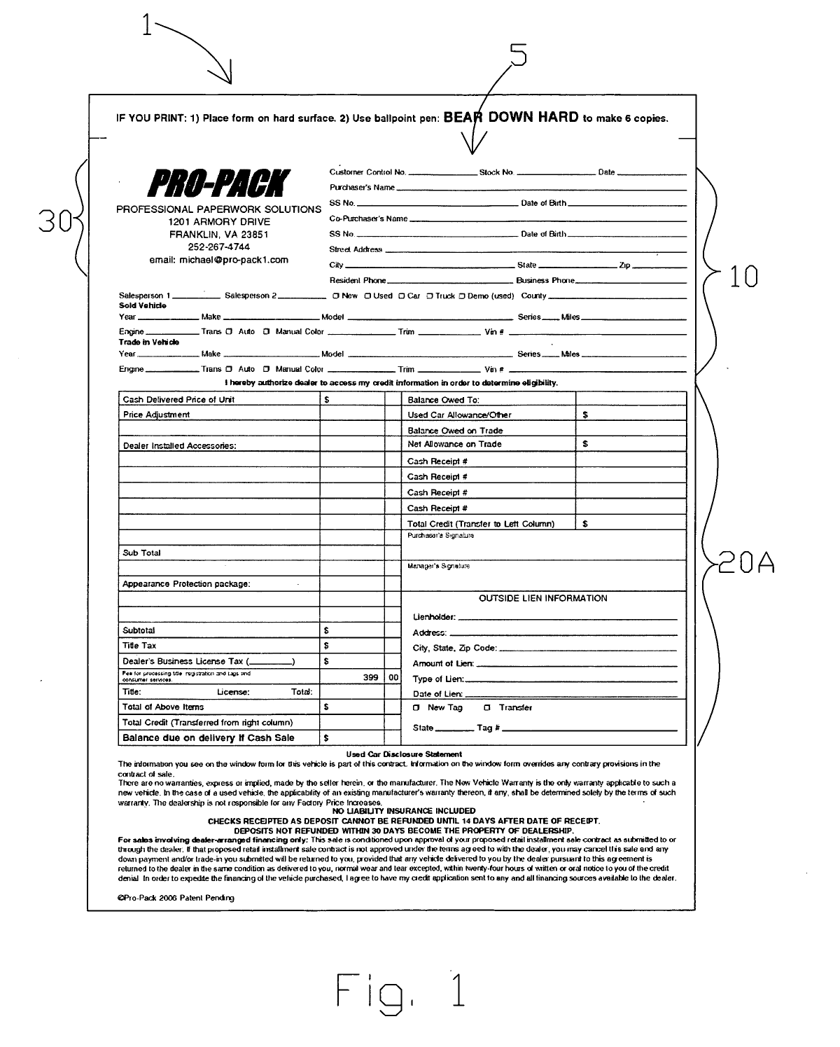

FIG. 1 is a first sheet in the novel form.

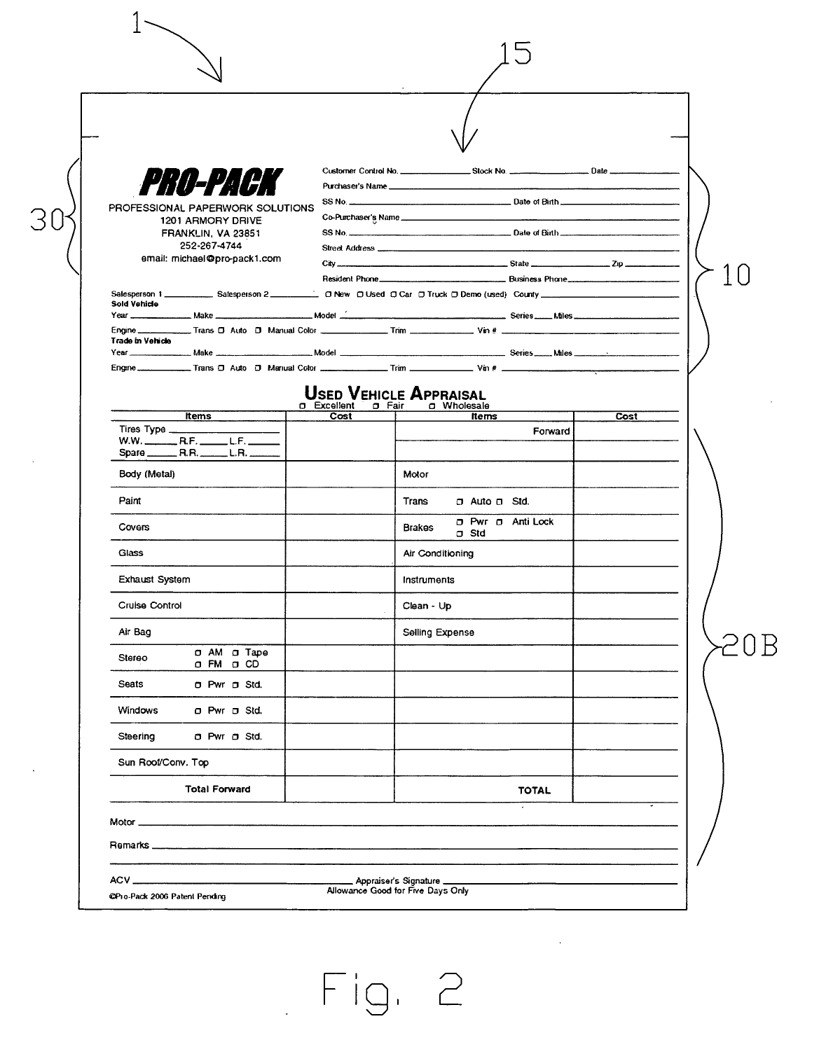

FIG. 2 is a second sheet in the novel form.

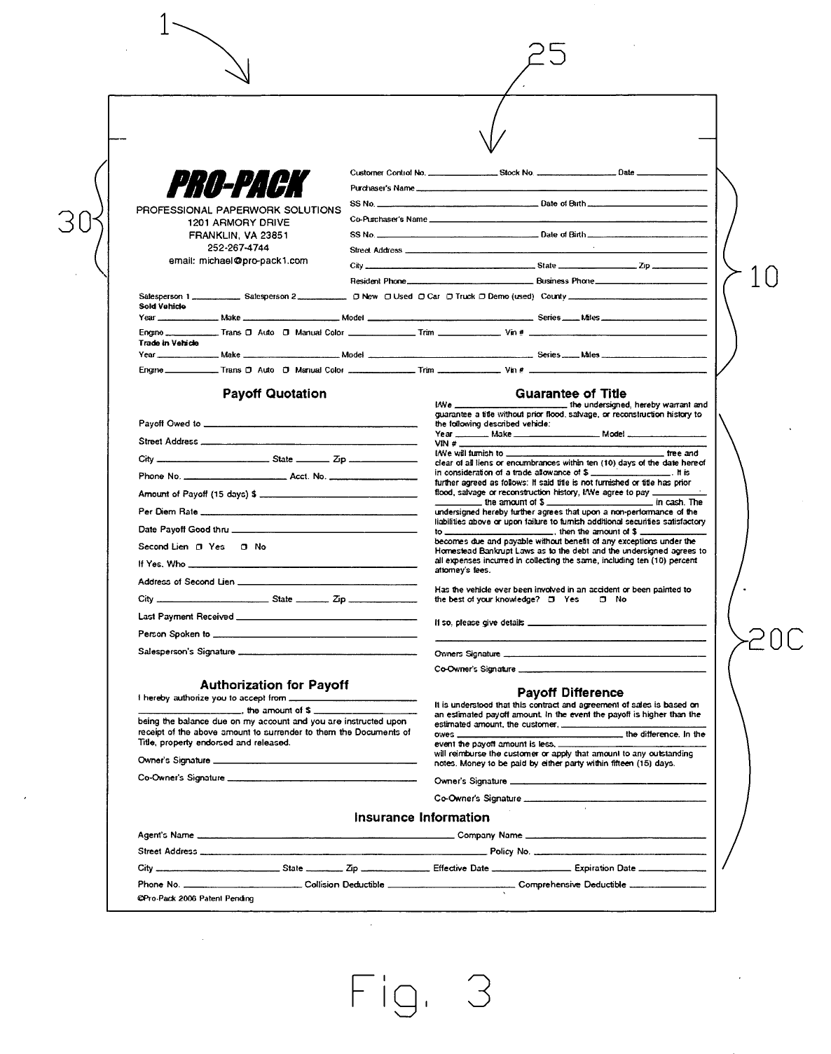

FIG. 3 is third sheet in the novel form.

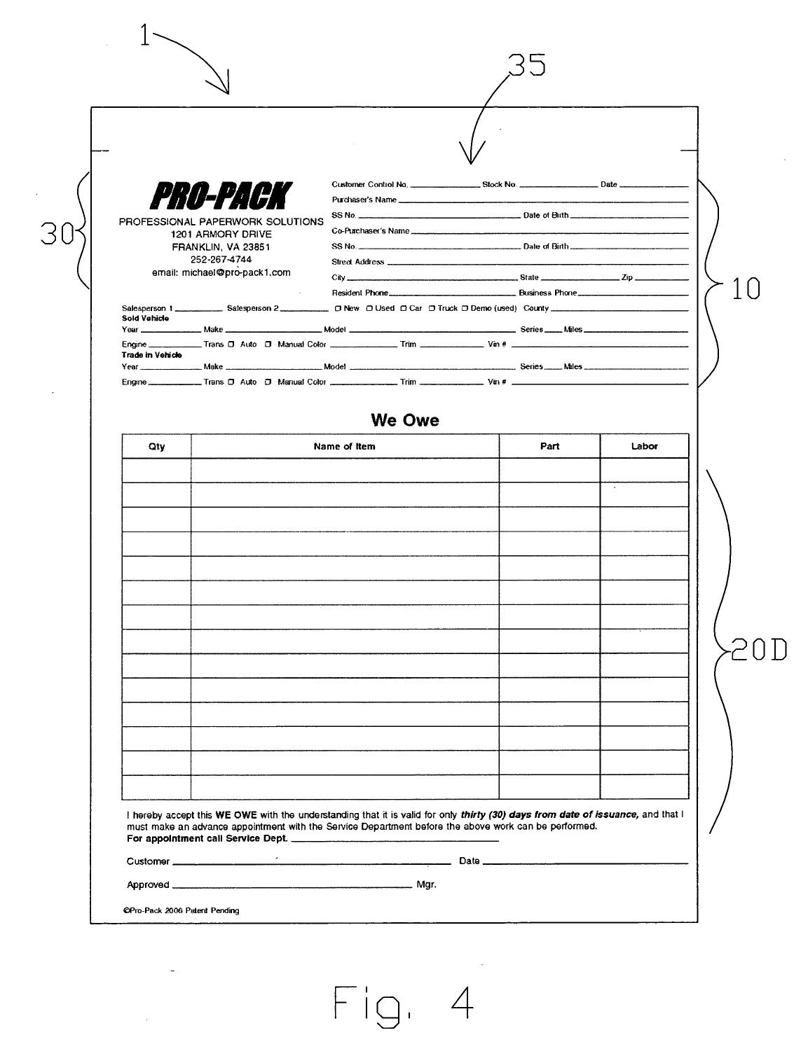

FIG. 4 is a fourth sheet in the novel form.

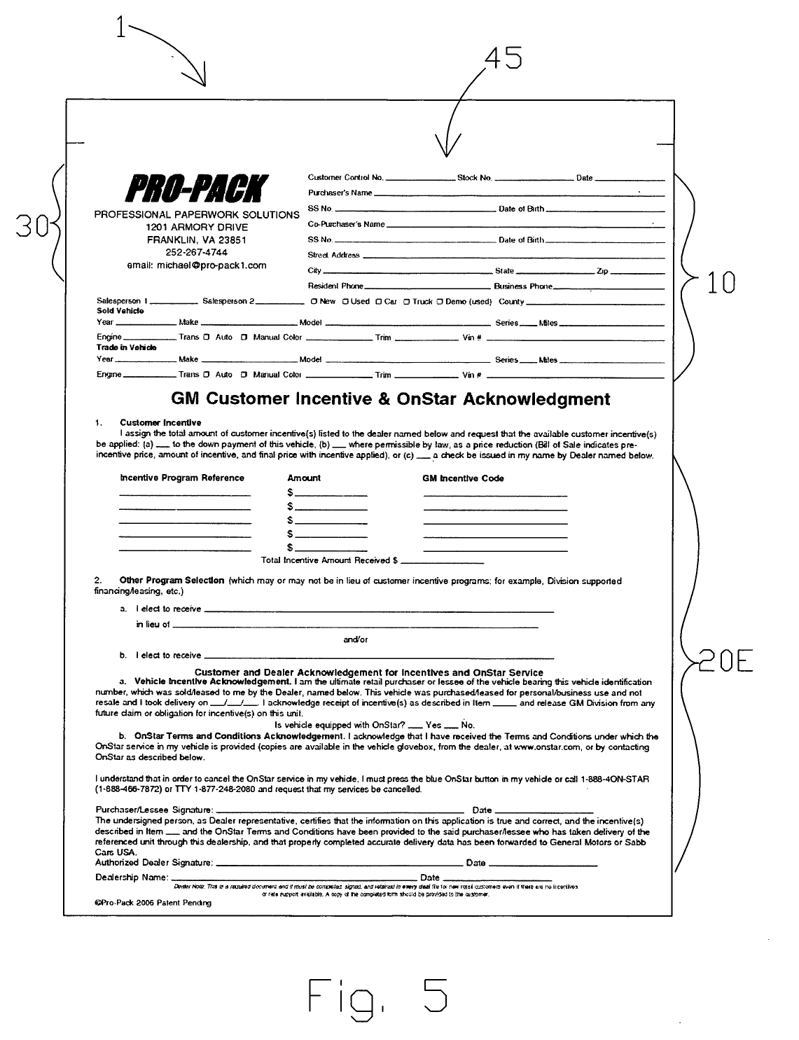

FIG. 5 is a fifth sheet in the novel form.

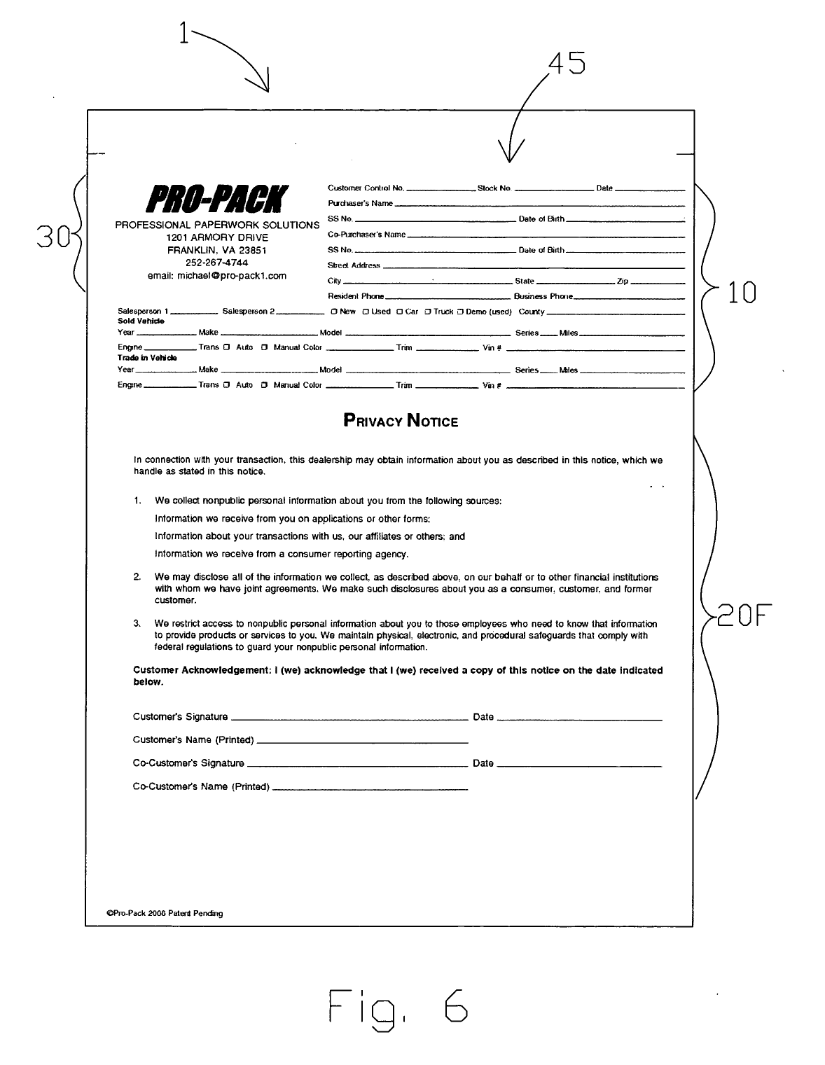

FIG. 6 is a sixth sheet in the novel form.

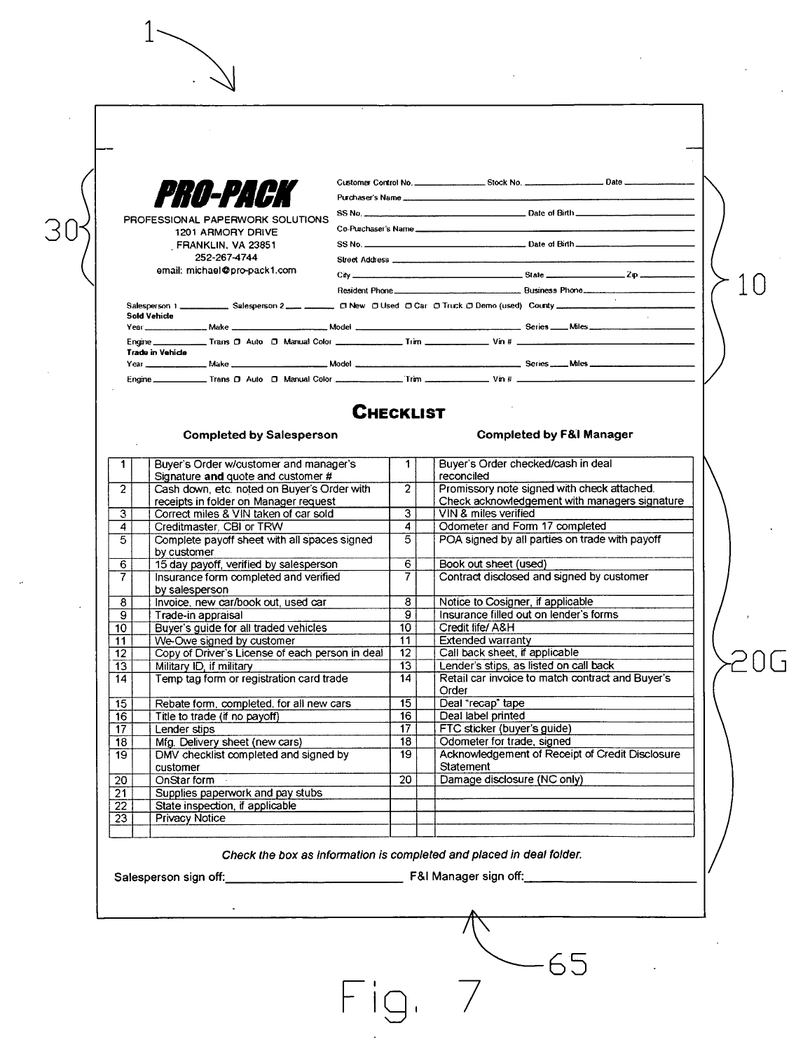

FIG. 7 is a seventh sheet in the novel form.

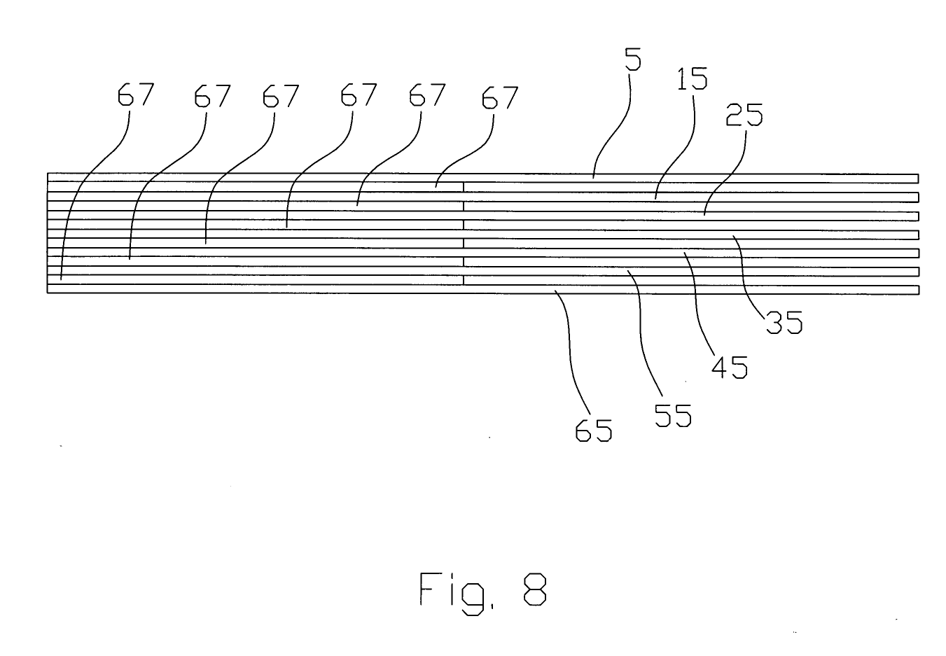

FIG. 8 is an elevated side view of a portion of the novel form being implement through use of carbon paper.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

FIG. 1 is a first sheet 5 of a multi-ply form 1 that includes a plurality of data fields. As can be recognized when reviewing FIGS. 1-7, which reflects the first through seventh sheet of paper respectively. It should be understood that the sequence of the forms is unimportant and the order in which the sheets are arranged within the form may be varied as understood by the skilled artisan. The first data region 10 preferably comprises one or more of the following data entry fields that may be filled out by a sales person or an intake person: a customer control number; a stock number; the date; a purchaser's name, customer identification number, address and date of birth; a co-purchaser's name, customer identification number, address and date of birth; resident information such as county or city of residence; contact information such as telephone numbers or email address; sales or intake persons name or other identifying indicia; vehicle specific information such as make of vehicle, year, model, series, mileage and vehicle identification number; engine specific information such as size; and transmission information such as automatic or manual, and the salesperson(s) name or indicator number. The information entered into the data entry fields above may be used for new or used vehicles as well as trade-in vehicles. Moreover, the information in the first data field 10 is reproduced on all of the pages of the multi-page form and is automatically transposed onto the appropriate location in the first data field when the first page 5 is filled out by the sales or intake person.

As shown in FIG. 1, the third data field 30 includes data that is dealership specific and includes the trademark or name of the dealership. The second data field 20A includes data entry fields that relate to one or more of the following: the cash price of the vehicle to be sold; any adjustments to the price of the vehicle; any dealer installed accessories including an appearance protection package; the title tax for transferring the title from the dealership to the customer; the automobile dealer's business license tax; fees for processing the automobile sales paperwork; subtotals; total amount of credit; balance due on delivery for cash sales; balanced owed to; used car or other allowances; balance owed on a trade-in; net allowance on an automobile that is being traded for a portion of the purchase price; cash receipt numbers; total credit; purchaser's signature; manager's signature; external lien information including the lien-holder's name, address, amount of lien, type of lien, and date of lien; new tags or transferring old tags; as well as a used car disclosure section. Preferably, the second data field 20A is filled out by the intake or sales person and may be provided in a table format.

As shown in FIG. 2, the first 10 and third data fields 30 are the same as presented in FIG. 1, this commonality is included in FIGS. 3-7. Thus, the first data fields 10 and third data fields 30 of all pages of the form are duplicative of the first and third data fields of the first page. The difference between the first data field 10 and third data field 30 is that third data field 30 comprises information that is printed on each sheet prior to information being entered into the first data field 10 by a sales person or the like. The forms may be created by printing the third data fields 30 and the data entry fields of the first and second data fields 10, 20A-20G on each sheet separately and then gluing them together. Only a portion of each form relating to the respective size of the first data field 10 allows writing from the first page to be duplicated onto later pages of the form. This is created by only providing a half of carbon copy between succeeding pages of the form. Optionally, each sheet of paper, elements 5, 15, 25, 35, 45, 55, 65, includes only a portion of the back that includes a region that automatically reproduces carbon copies onto a later page of the form as in carbonless copies. The sheet of carbon copy material may be arranged on any of the four sides including the top, bottom, left and right sides. Carbon copy material or the back of each form is arranged only in the first data region 10 to allow printing in the first data region 10 to be transferred from the first page and transposed onto pages 2 through 7 of the form, represented by FIGS. 2-7.

FIG. 2 shows sheet 15 that includes a second data region 20B that comprises a table for use with a used vehicle appraisal. Included in the table are important features present on a used vehicle that is being bought or sold by the dealership. The table includes a rating feature that allows the sales person or other individual to act as an appraiser and rate the condition of the used automobile from excellent, fair or wholesale. Vehicle features such as the tire type and condition of each tire are included in the table for allowing the appraiser a checklist for assessing the value of the vehicle. Other features provided include fill-in blanks or data entry fields relating to the condition of the automobile body including the paint job, covers, glass, exhaust system, cruise control, air bag, stereo, seats, windows, steering, sun roof or convertible, motor, transmission, brakes, air conditioning, instrument gauges or clusters, the cleanliness of the interior and exterior and selling expenses involve. A data entry field is included for a total assessed value. A remarks section may be included as shown.

FIG. 3 shows sheet 25 that includes a second data region 20C that relates to a payoff quotation, a guarantee of title, an authorization for payoff, a payoff difference and insurance information. The payoff quotation section includes data entry fields for entering information relating to the identity of the individual or entity to whom the debt is owed along with appropriate indicia including an address, telephone number, account number, amount of payoff, per diem rate and payoff date. A section is provided for indicating whether the automobile is subject to a second lien. If so the identity of the individual or entity who is the secondary lien holder along with appropriate indicia including an address and the sales person's signature.

The authorization for payoff section is authorization whereby the owner instructs the lien holder to receive an amount of money from the dealership and provide the title documents to the dealership. The guarantee of title section is a warranty from the customer warranting that the customer owns and guarantees the title of the trade-in. This section identifies the trade-in through identifying indicia such as the year, make, model and vehicle identification number of the trade-in. The guarantee of title further binds the customer as shown and confirms that the trade-in vehicle has not been subject to flood damage, salvage or reconstructing. The payoff difference section includes an agreement between the customer and the dealership whereby the customer agrees that pay for some or all of the payoff difference. Insurance information includes the agent's name, company name, address, policy number, telephone number, and appropriate deductions.

FIG. 4 shows sheet 35 that includes a second data region 20D that is a worksheet for the dealership as shown. This worksheet states that it will undertake certain and perform certain maintenance functions within a certain period of time after the customer has purchased the automobile. This section is especially useful for aiding in selling the vehicle by provided the dealership with further bargaining power. The worksheet includes table headings including the quantity, name of item, the cost of the parts and labor costs. This is commonly referred to the “we owe” agreement as indicated atop the table.

FIG. 5 shows sheet 45 that includes a customer incentive sheet and acceptance of other service contracts such as OnStar™, Sirius™ and the like. Fill-in spaces are provided for incentive program references, amounts and incentive codes. This section also includes the customer and dealer acknowledgment for incentives and services.

FIG. 6 shows sheet 55 that includes a privacy notice which sets forth the terms and conditions under which the dealership will release personal information of the customer and restriction to release of the information to others.

FIG. 7 shows sheet 65 that is a checklist that is provide for use by both the sales person and the finance department manager of the dealership. The checklist ensures that each of these individuals have performed all of the necessary tasks for selling a vehicle to a customer.

FIG. 8 is a partial view exploded view of the form 1 and showing one embodiment that includes carbon paper 67 arranged between the first sheet 5 and the second sheet 15. The carbon paper 67 is also arranged between each succeeding sheet as can be understood by the skilled artisan.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A form for selling an item, said form comprising:
a first sheet of paper comprising a front face and a back face, said front face having at least a first data region and a second data region printed thereon, each data region including areas that are left blank to be filled in with specific information prior to transferring ownership of the item from one person to another, said back face arranged to transfer information from the first data region of the first sheet of paper onto a succeeding sheet of paper in contact with the back face;
a second sheet of paper comprising a front face and a back face, said front face of the second sheet of paper having at least the same first data region of the first sheet of paper and a second data region that is different than the second data region of the first sheet of paper, said second data region printed thereon, each data region including areas that are left blank to be filled in with specific information prior to transferring ownership of the item from one person to another, said back face arranged to transfer information from the first data region of the second sheet of paper onto a succeeding sheet of paper in contact with the back face;
a third sheet of paper comprising a front face and a back face, said front face of the third sheet of paper having at least the same first data region of the first sheet of paper and a second data region that is different than the second data region of the first and second sheets of paper, each data region including data entry areas that are left blank to be filled in with specific information prior to transferring ownership of the item from one person to another, said back face arranged to transfer information from the first data region of the third sheet of paper onto a succeeding sheet of paper in contact with the back face;
a fourth sheet of paper comprising a front face and a back face, said front face of the fourth sheet of paper having at least the same first data region of the first sheet of paper and a second data region that is different than the second data region of the first, second and third sheets of paper, each data region including data entry areas that are left blank to be filled in with specific information prior to transferring ownership of the item from one person to another, said back face arranged to transfer information from the first data region of the fourth sheet of paper onto a succeeding sheet of paper in contact with the back face;
a fifth sheet of paper comprising a front face and a back face, said front face of the fifth sheet of paper having at least the same first data region of the first sheet of paper and a second data region that is different than the second data region of the first, second, third and fourth sheets of paper, each data region including data entry areas that are left blank to be filled in with specific information prior to transferring ownership of the item from one person to another, said back face arranged to transfer information from the first data region of the fifth sheet of paper onto a succeeding sheet of paper in contact with the back face;
a sixth sheet of paper comprising a front face and a back face, said front face of the sixth sheet of paper having at least the same first data region of the first sheet of paper and a second data region that is different than the second data region of the first, second, third, fourth and fifth sheets of paper, each data region including data entry areas that are left blank to be filled in with specific information prior to transferring ownership of the item from one person to another, said back face arranged to transfer information from the first data region of the sixth sheet of paper onto a succeeding sheet of paper in contact with the back face; and,
a seventh sheet of paper comprising a front face and a back face, said front face of the seventh sheet of paper having at least the same first data region of the first sheet of paper and a second data region that is different than the second data region of the first, second, third, fourth, fifth and sixth sheets of paper, each data region including data entry areas that are left blank to be filled in with specific information prior to transferring ownership of the item from one person to another.

2. The form of claim 1 wherein said first sheet of paper is a financial worksheet.

3. The form of claim 2 wherein the second data field consists of one or more selected from a group consisting of the cash price of the vehicle to be sold, any adjustments to the price of the vehicle, any dealer installed accessories including an appearance protection package, a title tax for transferring the title from the dealership to the customer, an automobile dealer's business license tax, fees for processing automobile sales paperwork, subtotals, total amount of credit, balance due on delivery for cash sales, balanced owed to the dealership, used car or other allowances, balance owed on a trade-in, net allowance on an automobile that is being traded for a portion of the purchase price, cash receipt numbers, total credit, a purchaser's signature, a dealership manager's signature, external lien information including a lien-holder's name, address, amount of lien, type of lien, and date of lien, new tags or transferring old tags, as well as a used car disclosure section.

4. The form of claim 1 wherein said second sheet of paper is a used car and trade-in worksheet.

5. The form of claim 4 wherein said second sheet of paper includes one or more data entry fields selected from a group consisting of important features present on a used vehicle that is being bought or sold by the dealership, a rating feature that allows the sales person or other individual to act as an appraiser and rate the condition of the used automobile from excellent, fair or wholesale, vehicle features such as the tire type and condition of each tire that allows an appraiser a checklist for assessing the value of the vehicle, the condition of the automobile body including the paint job, covers, glass, exhaust system, cruise control, air bag, stereo, seats, windows, steering, sun roof or convertible, motor, transmission, brakes, air conditioning, instrument gauges or clusters, the cleanliness of the interior and exterior and selling expenses involve, a total assessed value and a remarks section.

6. The form of claim 1 wherein said third sheet of paper is a trade-in payoff worksheet and guarantee of title sheet.

7. The form of claim 6 wherein said third sheet of paper includes one or more data entry fields selected from a group consisting a payoff quotation, a guarantee of title, an authorization for payoff, a payoff difference and insurance information, an identity of the individual or entity to whom the debt is owed along with appropriate indicia including an address, telephone number, account number, amount of payoff, per diem rate and payoff date, an indication whether the automobile is subject to a second lien, an identity of the individual or entity who is the secondary lien holder along with appropriate indicia including an address and the sales person's signature, authorization whereby an automobile owner instructs the lien holder to receive an amount of money from the dealership and provide the title documents to the dealership, a guarantee of title section including a warranty from the customer warranting that the customer owns and guarantees the title of a trade-in, an identification of the trade-in automobile through identifying indicia such as the year, make, model and vehicle identification number of the trade-in, insurance information that includes an insurance agent's name, company name, address, policy number, telephone number, and appropriate deductions.

8. The form of claim 1 wherein said fourth sheet of paper is a service department worksheet.

9. The form of claim 8 wherein said fourth sheet of paper includes one or more data entry fields selected from a group consisting of certain maintenance functions that will be performed within a certain period of time after a customer has purchased an automobile including a quantity, a name of item, a cost of parts and labor costs.

10. The form of claim 1 wherein said fifth sheet of paper is a customer incentive worksheet.

11. The form of claim 10 wherein said fifth sheet of paper is a customer incentive sheet and acceptance of other service contracts including data entry fields that are provided for incentive program references, amounts, incentive codes and customer and dealer acknowledgment for incentives and services.

12. The form of claim 1 wherein said sixth sheet of paper is a privacy notice.

13. The form of claim 12 wherein said privacy notice sets forth the terms and conditions under which the dealership will release personal information of the customer and restriction to release of the information to others.

14. The form of claim 1 wherein said seventh sheet of paper is a salesperson checklist.

15. The form of claim 14 wherein said salesperson checklist includes data entry fields that all necessary tasks for selling a vehicle to a customer are performed.

16. A form for selling an article for sale, said selling the article for sale including transferring title from a first owner to a second owner, said form comprising:
a plurality of sheets of paper overlapping one another;
an area on each of the sheets that reproduces common information on a succeeding sheet of paper of the form; and,
another area of each of the sheets that includes specific information for that particular sheet.

17. The form of claim 16 wherein said plurality of sheets of paper include one or more selected from a group consisting of a financial worksheet, a used car and trade-in worksheet, a trade-in payoff worksheet and guarantee of title sheet, a service department worksheet, a customer incentive worksheet, a privacy notice and a salesperson checklist.

18. A process of transferring title of an item for sale from one to another, said process comprising:
providing a form for selling the item, said form comprising a first sheet of paper comprising a front face and a back face, said front face of the first sheet having at least a first data region and a second data region printed thereon, each data region of the first sheet including areas that are left blank to be filled in with specific information prior to transferring ownership of the item from one person to another, said back face arranged to transfer information from the first data region of the first sheet of paper onto a succeeding sheet of paper in contact with the back face, a second sheet of paper comprising a front face and a back face, said front face of the second sheet of paper having at least the same first data region of the first sheet of paper and a second data region that is different than the second data region of the first sheet of paper, said second data region printed thereon, each data region including areas that are left blank to be filled in with specific information prior to transferring ownership of the item from one person to another, said back face arranged to transfer information from the first data region of the second sheet of paper onto a succeeding sheet of paper in contact with the back face, a third sheet of paper comprising a front face and a back face, said front face of the third sheet of paper having at least the same first data region of the first sheet of paper and a second data region that is different than the second data region of the first and second sheets of paper, each data region including data entry areas that are left blank to be filled in with specific information prior to transferring ownership of the item from one person to another, said back face arranged to transfer information from the first data region of the third sheet of paper onto a succeeding sheet of paper in contact with the back face, a fourth sheet of paper comprising a front face and a back face, said front face of the fourth sheet of paper having at least the same first data region of the first sheet of paper and a second data region that is different than the second data region of the first, second and third sheets of paper, each data region including data entry areas that are left blank to be filled in with specific information prior to transferring ownership of the item from one person to another, said back face arranged to transfer information from the first data region of the fourth sheet of paper onto a succeeding sheet of paper in contact with the back face, a fifth sheet of paper comprising a front face and a back face, said front face of the fifth sheet of paper having at least the same first data region of the first sheet of paper and a second data region that is different than the second data region of the first, second, third and fourth sheets of paper, each data region including data entry areas that are left blank to be filled in with specific information prior to transferring ownership of the item from one person to another, said back face arranged to transfer information from the first data region of the fifth sheet of paper onto a succeeding sheet of paper in contact with the back face, a sixth sheet of paper comprising a front face and a back face, said front face of the sixth sheet of paper having at least the same first data region of the first sheet of paper and a second data region that is different than the second data region of the first, second, third, fourth and fifth sheets of paper, each data region including data entry areas that are left blank to be filled in with specific information prior to transferring ownership of the item from one person to another, said back face arranged to transfer information from the first data region of the sixth sheet of paper onto a succeeding sheet of paper in contact with the back face, and a seventh sheet of paper comprising a front face and a back face, said front face of the seventh sheet of paper having at least the same first data region of the first sheet of paper and a second data region that is different than the second data region of the first, second, third, fourth, fifth and sixth sheets of paper, each data region including data entry areas that are left blank to be filled in with specific information prior to transferring ownership of the item from one person to another;
entering information into an appropriate data entry field in the first data region on the first data sheet such that said information is reproduced on all the first data regions of the second through seventh sheets;
disassembling the form and forwarding each of the second through seventh sheets to an appropriate department; and,
entering information into the second data regions of the second through seventh sheets to transfer ownership of an item to a customer.
